(19) United States
(12) Patent Application Publication
(10) Pub. No.: US 2013/0017516 A1
(43) Pub. Date: Jan. 17, 2013

(54) ACTIVE BRAILLE TIMEPIECE & RELATED METHODS

(71) Applicant: Kelly Tyler, Jamul, CA (US)

(72) Inventor: Kelly Tyler, Jamul, CA (US)

(21) Appl. No.: 13/180,351

(22) Filed: Jul. 11, 2011

(51) Int. Cl. G09B 21/00

(52) U.S. Cl. 434/114

(57) ABSTRACT

A timepiece adapted for efficient mechanical display of time and date according to a condensed Braille number format, the timepiece including a Braille actuation mechanism comprising a plurality of servo motors, translational pins, and similar components. The timepiece is adapted to display time (hour:minute), and date (month:day) using Braille character cells in accordance with a condensed Braille format. Additionally, the timepiece is adapted for scrollable Braille representations such that a user can set the time, date, and an optional alarm. Certain methods for providing a Braille display of numeric information are further disclosed.

### FIELD OF THE INVENTION

This invention relates to time pieces including clocks and wristwatches; and more particularly to such time pieces adapted to display information such as time or date in accordance with a Braille format.

### BACKGROUND OF THE INVENTION

Braille was introduced in the 1800's and has since become the universal written communications format for those with limited vision, or the blind. Each Braille character, or cell, generally consists of six dot positions, arranged in a rectangle having two columns, each of the columns containing three dots therein. A dot may be raised at any of the six positions to form sixty-four (2⁶) possible subsets, including the arrangement in which none of the dots are raised. For reference purposes, a particular permutation may be described by naming the positions where dots are raised, the positions being universally numbered 1 to 3, from top to bottom, on the left, and 4 to 6, from top to bottom, on the right. For example, dots 1-4-5 would describe a cell with three dots raised, at the top in the left column and on the top and middle of the right column, i.e., the Braille representation of the number “4”. The lines of horizontal Braille text are separated by a space, much like visible printed text, so that the dots of one line can be differentiated from the Braille text above and below. More information about the Braille format can be obtained through an online search.

FIG. 1 illustrates the commonly known Braille number format including ten numeric digits from 0-9 and their respective Braille characters.

Certain attempts to provide a timepiece for the visually impaired have been described in the art. For example, certain modern digital watches have been adapted with an audible tone for communicating time to a user. Although the audible tone is often effective, such a watch can be a detriment when used at a library or under a circumstance where noise is discouraged.

Another timepiece provided for the visually impaired includes an analogue dial comprising incremental markers adapted with a Braille format. In this regard, a user flips open a cover to access the timepiece, reads the position of the hour and second hands relative to the incremental markers, and closes the cover. These analogue Braille watches can be effective, however it is often the case that the hour and second hands become bent or damaged following standard use. Furthermore, the time can be inaccurate where a user mistakenly moves one or both of the minute and second hands when effectuating a read. Accordingly, an improvement in the art can be recognized with increased durability and rigid construction of a Braille timepiece.

More recently, a timepiece has been suggested comprising a plurality of rotationally translational discs for displaying time according to a Braille number format (http://www.hapticatech.com). Each disc has a dot configured thereon such that the disc can rotate to expose/hide the dot. Here, four discs are required to display a single Braille character, thus a dozen or more rotationally translational discs are required to display time in Braille. Accordingly, such a watch would require a large surface area to hide unused dots. Additionally, the added size of the watch brings additional weight. Furthermore, the power to rotate the several discs would limit battery life.

There has yet to be provided a timepiece adapted to actively communicate Braille formatted information such as time or date to a user, such that the Braille characters are adapted for active reconfiguration upon a request from the user, or with active continuous actuation.

### SUMMARY OF THE INVENTION

These and other limitations in the art are overcome by the present invention, wherein an active Braille timepiece is provided. The active Braille timepiece generally includes a dial, watch surface, or face, having a substantially planar surface thereof, and a plurality of numeric Braille characters, or cells, each cell comprising four dots disposed about two columns, wherein each column includes two of the four dots. In this regard, each dot can be referred to as 1 and 2 in the top and bottom of the left column, respectively, and dots 3 and 4 in the top and bottom of the right column, respectively. Each of the dots is formed by a distal end of a translational pin, wherein each translational pin is adapted for actuation along an axis that is perpendicular to the dial, or face. Any of several embodiments can be implemented for translating the pins, and hence displaying the dots on the face of the time piece. A central processing unit (CPU) is provided for maintaining time, date, or other information. The CPU provides instructions for actuating the translational pins such that corresponding dots are positioned above the dial surface, thereby enabling a user to read time, date, or other information according to a Braille format.

In certain embodiments, the timepiece is a wristwatch. The wristwatch further comprises a vibrating motor for alerting a user of an alarm function. In this regard, the user can set a time for activating the alarm using standard buttons.

The timepiece can be adapted for display of 24-hour (military time), or 12 hour time formats. Additionally, the timepiece can be adapted for display of an a.m./p.m. indicator. In certain embodiments, the a.m./p.m. indicator includes a single supplemental pin adapted for actuation about a dial of the timepiece from a first recessed position to a second raised position using an actuator or similar mechanism.

### BRIEF DESCRIPTION OF THE DRAWINGS

These and other attributes of the invention are further described in the following detailed description, particularly when reviewed in conjunction with the drawings, wherein:

FIG. 1 illustrates prior art Braille numerical characters zero through nine in a standard six-dot Braille rectangle character format;

FIG. 2 illustrates a condensed Braille number format requiring only four dots, the condensed Braille numbers read substantially similar to the prior art format, however only four dots are required for display;

FIG. 3 illustrates a timepiece according to certain embodiments of the invention, wherein a wristwatch comprises a dial and a series of Braille characters being actively displayed thereon;

FIG. 4 illustrates a timepiece according to various embodiments of the invention, wherein a wristwatch similar to that illustrated in FIG. 3 further comprises a digital display;

FIG. 5 illustrates a general schematic of an active Braille timepiece according to various embodiments of the invention, the timepiece generally includes a CPU, and a series of translational pins adapted for actuation perpendicularly about a dial surface;

FIGS. 6(a-h) illustrate several embodiments for actuating translational pins about a dial surface, the embodiments illustrating un-actuated and actuated configurations of a spring lever, dome cap, cam shaft, and direct drive schemes; and

FIG. 7 illustrates several steps of a method for displaying time using an active Braille timepiece according to any of the embodiments of the invention.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

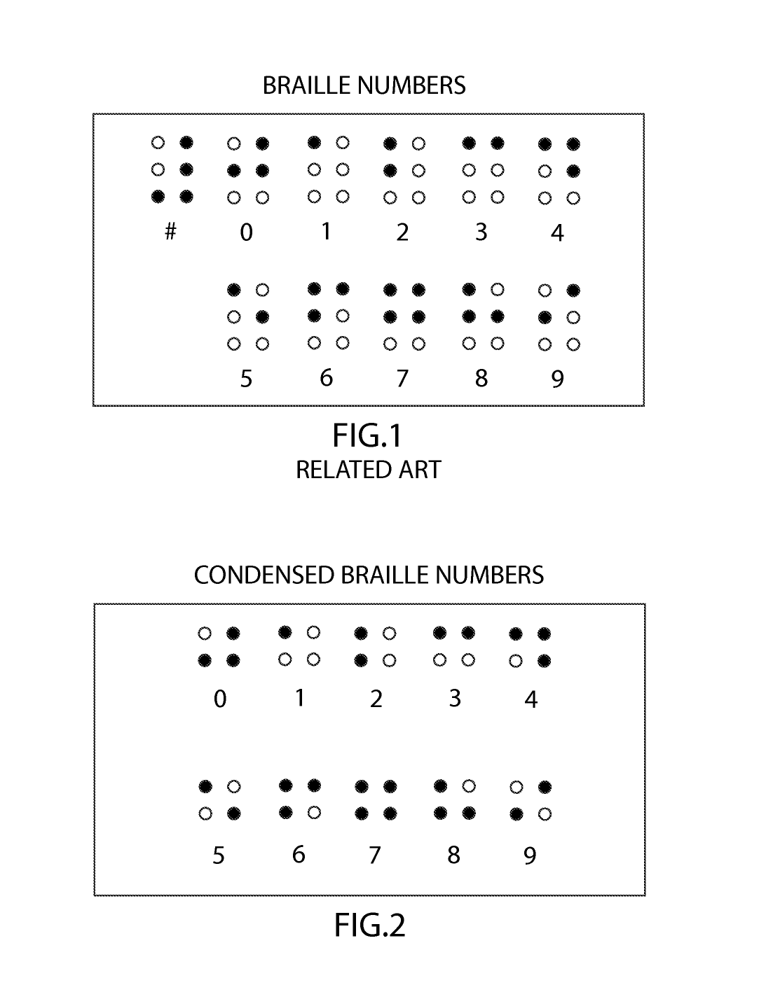

Braille numbers, like Braille letters, are generally displayed in a six-dot format consisting of two columns having three dots in each column. FIG. 1 illustrates a typical six-dot Braille representation of numeric digits zero through nine.

However, because each of the numeric digits zero through nine requires only the use of a common four of the six dots, the Braille number format can be condensed into a four-dot format as illustrated in FIG. 2. As shown, each of the four dots is disposed equidistant from a center point of the Braille cell in a square orientation. A predetermined space is implemented between Braille cells to provide distinction therebetween.

With a condensed Braille number format requiring only two thirds of the “dots” of the general Braille number format (see FIGS. 1-2), an active Braille actuation mechanism can be provided which requires less operational power. In addition to reducing power, size requirements are greatly reduced, thereby providing a light and small form for added convenience, portability, and improved aesthetics. Furthermore, the manufacturing and corresponding retail costs can be significantly reduced in accordance with the condensed number format since fewer components are required for assembly of the timepiece.

Power consumption is a key design parameter in timepieces, especially wearable wristwatches. Because Braille timepieces require an amount of power to actuate each translational pin of an actuation mechanism, power conservation is a driving factor in development. Thus, by reducing the required dots for display such as by utilizing the proposed condensed Braille numeric format, power can be similarly reduced by about a third when compared to a similar mechanism functioning over a six-dot character scheme.

To further reduce power consumption, certain embodiments of the invention comprise an update button for instantaneous display of time, on demand. In these embodiments, the translational pins are not continuously translating to update time; rather the pins are translated on demand by pressing the update button. Upon activation of the update button, time is acquired from a central processing unit (CPU) and instructions are sent to the actuators of the Braille actuation mechanism for translating respective pins between a first recessed position and a second raised position about a dial surface such that an instantaneous read of time is displayed about the Braille actuation mechanism. In this regard, the time is displayed in Braille about the actuation mechanism upon user request, i.e. upon a push of the update button.

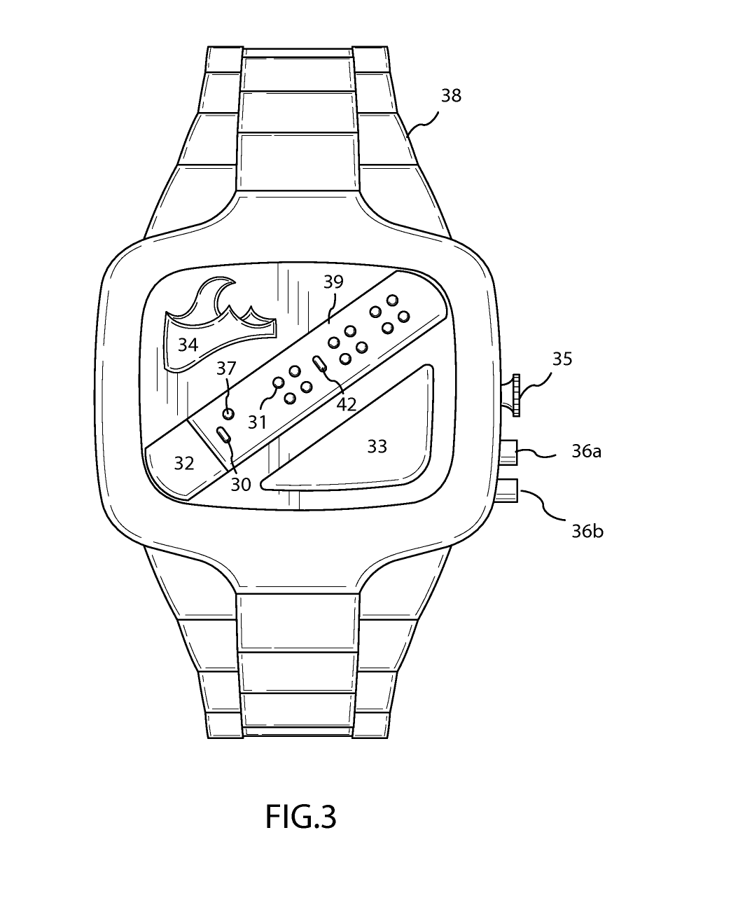

For purposes of this invention, the terms “dial” and “dial surface” are used herein to describe the face of a watch or clock, even where the face is not particularly round or arranged with graduated markings. The term “dial” is herein defined generally as the face of a timepiece as indicated in FIGS. 3 & 5.

In general, the invention includes a timepiece, such as a clock or a watch, being adapted to display time according to a condensed Braille number format. Each of the Braille characters, or cells, is made up of four dots, wherein each dot is formed by a distal end of a translational pin. The translational pins are actuated along one of several pin axes by an actuator, each of the axes is configured substantially perpendicular to a face, or dial surface. A given timepiece may comprise three or more Braille character cells. In certain embodiments, the three cells correspond to the format H:MM, where “H” represents the hour and “MM” represents minutes. Here, a supplemental dot can be used to indicate a “1” for hours between 10 and 12, for example when the current time is between 10:00 and 12:59.

In other embodiments, four cells are provided to display Braille time according to the format HH:MM (24-hour, or military time), where “HH” represents the hour and “MM” represents minutes in accordance with a 24-hour format.

In another embodiment, a supplemental dot can be used to indicate anti-meridiem (a.m.) or post-meridiem (p.m.) time values. For example, a supplemental dot can be configured to the far left of the Braille actuator on the dial of the timepiece, the supplemental dot can be actuated to a raised position with respect to the dial surface for indicating a post-meridiem hour. Similarly, the supplemental dot can be used to indicate an anti-meridiem hour, wherein the supplemental dot is configured in a recessed position, or flush with the dial surface. Other configurations can be provided such that a supplemental dot is adapted to communicate a Braille representation of a.m. and p.m. time.

In addition to displaying time about the Braille actuation mechanism, the timepiece can be further adapted to scroll through hours and minutes for the purpose of setting an alarm. This is generally accomplished using one or more scrolls and buttons to set the hour and minute requirements for the alarm. Once the hour and minute requirements are entered, the CPU can store the inputted information and activate an alarm upon reaching the desired time, as is commonly performed in most watches. One difference with respect to this watch includes that hours and minutes are displayed in Braille during the scrolling through, and setting, of the alarm. Thus a person having a visual impairment will be able to set the alarm using the Braille actuation mechanism and one or more scrolls or buttons.

In certain embodiments, a combination of buttons and scrolls can be utilized to set a first Braille cell, then subsequently set a second Braille cell, and repeat until each Braille cell is set in accordance with a user's intent. In this regard, the Braille cells are each individually set until the desired time is entered into the CPU of the timepiece. In other embodiments, the Braille actuation mechanism is adapted to scroll numerically through each minute and hour until the time indicated is in accordance with the user's intent. Other methods for implementing the alarm time/date settings can be tailored by those having skill in the art.

An optional ‘mode’ button can be provided for scrolling through time and date on the Braille actuation mechanism. In this regard, the mode button is configured to vary the mode of the CPU and Braille actuation mechanism between the display of time (H:MM) as described above, and date (M:DD), where “M” represents the current month and “DD” represents the day in accordance with a month/day format when in date mode. Similar to two-digit hours, two-digit months can be represented using a supplemental dot, which when raised above the dial surface indicates a “1” preceding the month cell. A supplemental actuator can be used to indicate the state of the time piece, for example whether “time” or “date” is being displayed in a given mode.

Other features commonly employed in watches can be further incorporated, such as three dimensional logos, digital displays such as an LCD display, and other features.

Now turning to the drawings, FIG. 3 illustrates a watch according to various embodiments of the invention. The watch includes a standard watch band 38, a three-dimensional logo 34, a series of push buttons 36(a-b), and a scroll 35. However, this watch is further distinguished from those in the prior art in that it comprises a Braille actuation mechanism comprising an elongated display of three Braille cells, each cell comprising four dots 31. Each of the dots is formed by a distal end of a translational pin, the pin being configured to translate between a first recessed position and a second raised position about the dial surface 39. Here, three Braille character cells are shown along with a single supplemental dot 37. The supplemental dot 37 is formed at a distal end of a supplemental pin. The supplemental pin, when raised above the dial surface, indicates a “1” for preceding the hour “H” or month “M” character cell for displaying two-digit hours, and months.

As described above, a second supplemental dot can be provided for representing a.m./p.m. time to a user. In this regard, the second supplemental dot can be configured in substantially the same manner as the first supplemental dot described above.

Additionally, one or more static indicators 30; 42 can be provided for designating function of a specific cell. For example, a first static indicator 30 can be positioned adjacent to a first supplemental dot 37 for indicating two-digit hours, or other information. In another example, a static indicator 42 is disposed between a first Braille cell and a second Braille cell such that a user may differentiate hour/month from minute/day. Other static indicators can be provided in accordance with the embodiments herein.

Furthermore, an update button 33 is provided for requesting an instantaneous display of time about the Braille actuation mechanism. A mode button 32 is provided for varying the mode of the watch CPU between time, date, continuous Braille movement, and power conserve mode requiring a request of the update button for instantaneous display of Braille time. The scroll 35 and buttons 36(a-b) can be programmed to scroll through hours, minutes, months, and days, such that a user can set the time and date, or set an alarm. Various programming algorithms can be implemented as would be understood by those having skill in the art. One significant difference includes that this watch is adapted to display the hour, minute, month, and day in Braille during scrolling and setting of the time/date.

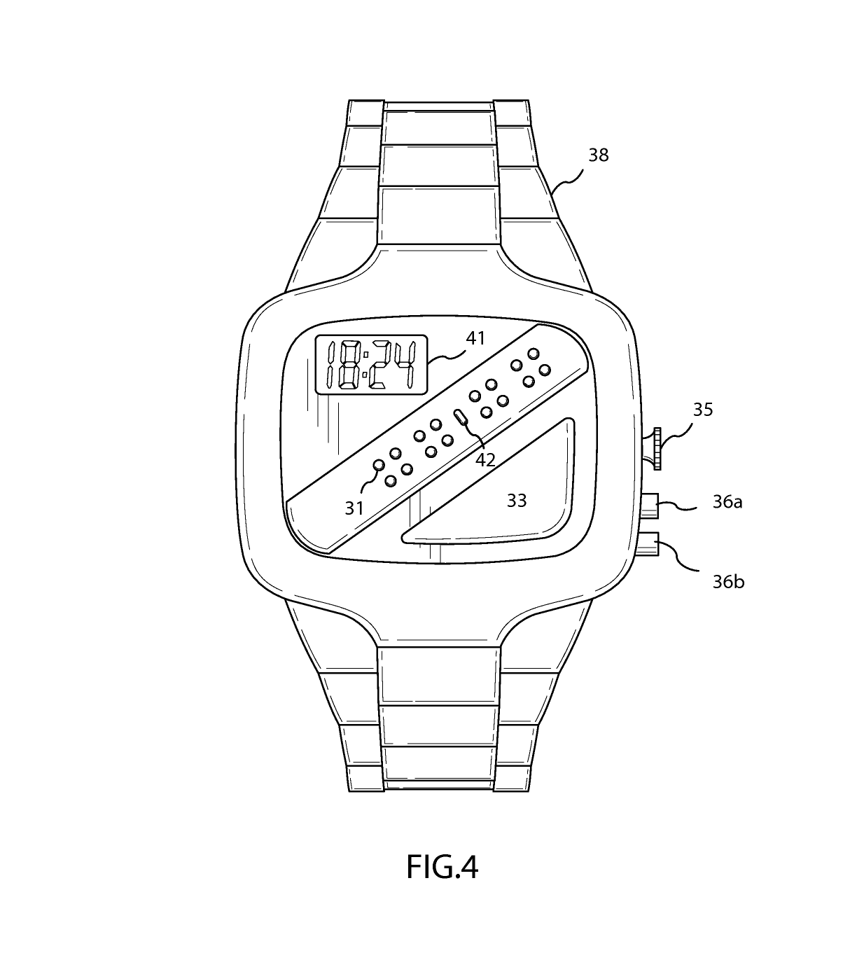

In certain other embodiments as illustrated in FIG. 4, the watch or timepiece can comprise four Braille character cells, such as for example a 24-hour time scheme. In this regard, the Braille actuation mechanism functions similarly as described in the preceding figure, however additional dots and corresponding translational pins/actuators are incorporated for providing an additional, or fourth Braille character cell. It should be noted that although useful, certain embodiments having four cells will require more power than the those having only three cells, or three cells and a supplemental dot.

Further illustrated in FIG. 4 is a digital display 41, such as an LCD display. In this regard, the watch can be adapted for Braille display as well as digital display. Accordingly, the watch is not merely limited for use by those having visual impairments, but is also useful for teaching Braille numbers to those with vision, or general use by those with and without visual impairments. In certain embodiments where a combination of Braille display and digital display are provided, a user can learn to read Braille numbers by associating Braille characters with visual confirmation of characters on a digital display.

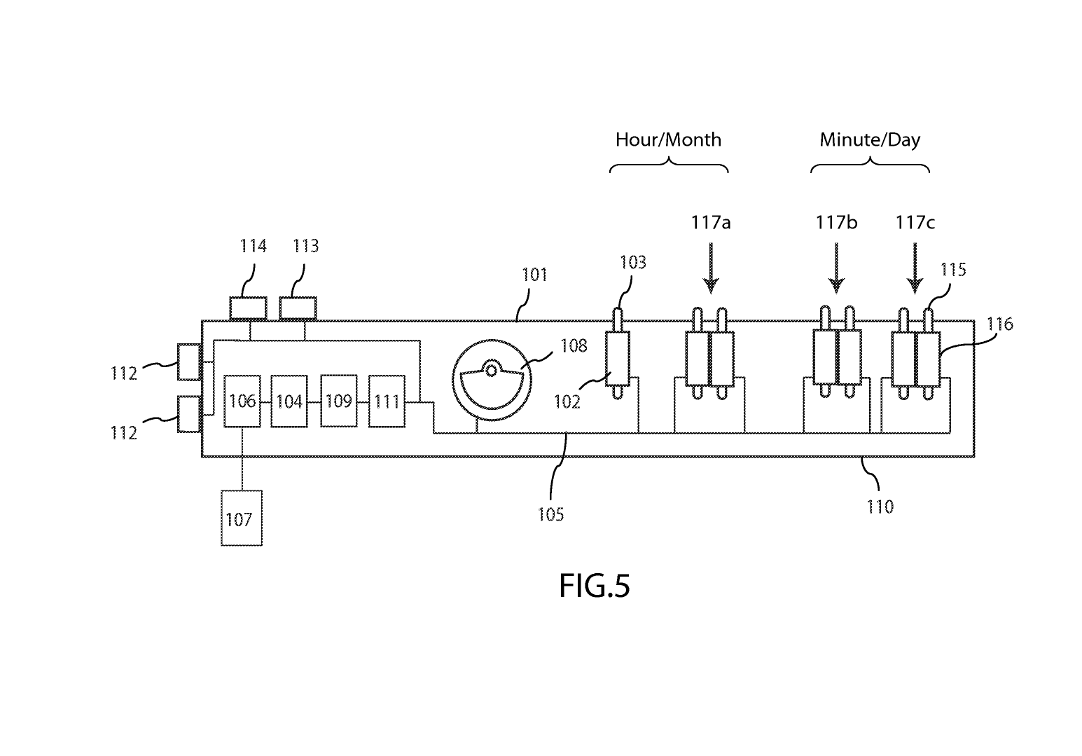

FIG. 5 is an example schematic of a timepiece according to various embodiments of the invention. The timepiece comprises a face, or dial surface 101 having one or more dots formed by translational pins 115 adapted for protruding therethrough from a first recessed position to a second raised position about the dial surface. One or more buttons, such as an update button 113 and a mode button 114 can further be configured to extend outwardly from the dial surface. In FIG. 5, three Braille character cells represent the hour, and minute portions, or alternatively the month, and day portions, of the Braille actuation mechanism. A supplemental translational pin 103 and supplemental actuator 102 are provided in this embodiment for displaying a “1” preceding two-digit hours, and months as described above. In this regard, an efficient Braille time display is provided.

The Braille character cells 117a-c are each connected to a CPU 111, and one or more of: a servo driver 109, a clock 104, and a power source 106. In certain embodiments, the CPU includes a clock. An optional power source charger 107, such as a mechanical winder, solar charger, or other charger can be connected to the power source 106. The mode and update buttons are further connected to the CPU via transmission lines. The scroll and push buttons 112 are further connected to the CPU. An optional vibrating motor 108 can be further incorporated for providing a vibrating alarm function to the timepiece. In this embodiment, the CPU controls the mode of the Braille display through use of the mode button, the update function of the Braille display through use of the update button, scrolling date, time and alarm setting functions with Braille display, and alarm functions using the vibrating motor.

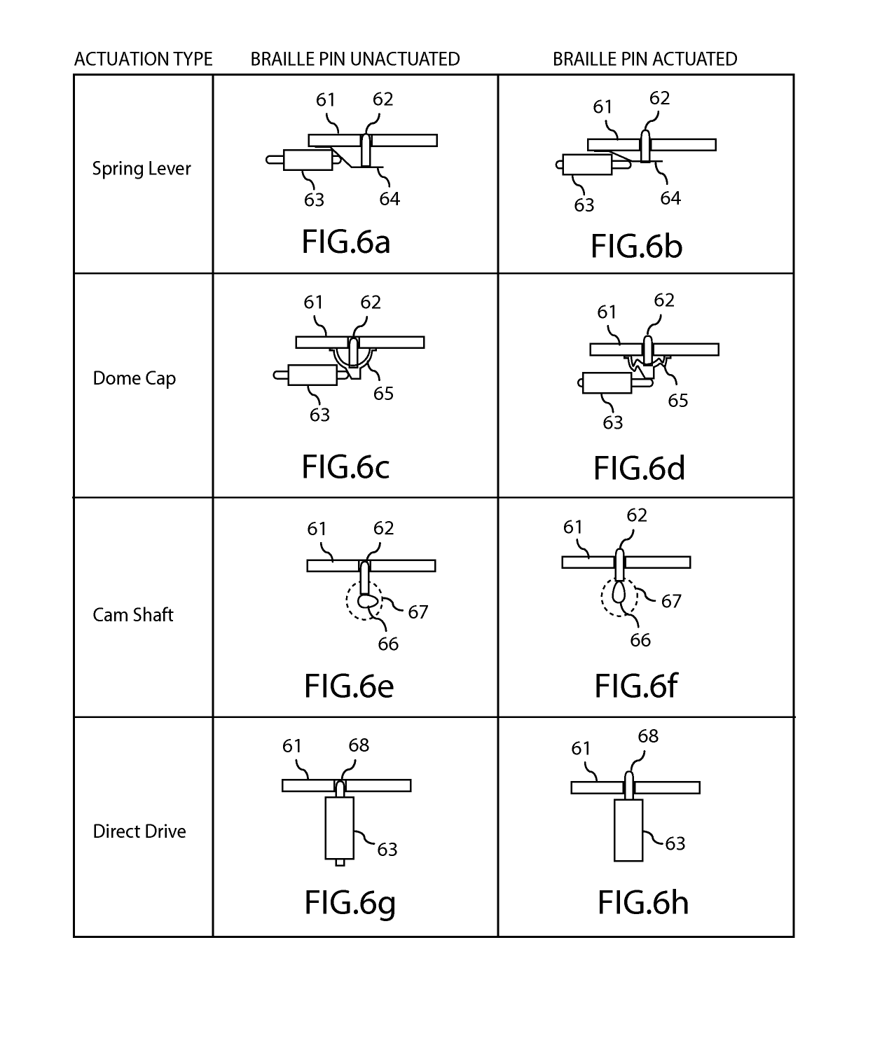

Although FIG. 5 illustrates the use of direct drive actuators 116, one or more alternative actuators may be alternatively incorporated to produce a similar result. For example, FIG. 6 illustrates a series of actuators in both an un-actuated, and an actuated state.

FIGS. 6a-b illustrate a spring lever actuator. The spring lever actuator is disposed adjacent to a dial surface 61 having an aperture adapted to at least partially receive a portion of a translational pin 62. The spring lever actuator comprises a linear actuator 63 adapted to depress a spring lever 64 for actuating the translational pin up and down about a translational axis perpendicular to the dial surface.

FIGS. 6c-d illustrate a dome cap actuator. The dome cap actuator is disposed adjacent to a dial surface 61 having an aperture adapted to at least partially receive a portion of a translational pin 62. The dome cap actuator comprises a linear actuator 63 adapted to depress a dome cap 65 for actuating the translational pin 62 up and down about a translational axis perpendicular to the dial surface.

FIGS. 6e-f illustrate a cam shaft actuator. The cam shaft actuator is disposed adjacent to a dial surface 61 having an aperture adapted to at least partially receive a portion of a translational pin 62. The cam shaft actuator comprises a motor 67 adapted to rotate a cam 66 for actuating the translational pin 62 up and down about a translational axis perpendicular to the dial surface.

FIGS. 6g-h illustrate a direct drive actuator. The direct drive actuator is disposed adjacent to a dial surface 61 having an aperture adapted to at least partially receive a portion of a translational pin 62. The direct drive actuator comprises a linear servo motor 63 adapted to actuate a translational pin 68 along a translational axis perpendicular to the dial surface.

In each of the actuator embodiments illustrated in FIGS. 6(a-h), the actuator 63 may comprise a linear motor, such as a linear servo motor, piezo motor, solenoid, or similar linear actuator, or a combination thereof. Such actuators are commercially available and can be implemented with minimal experimentation. In this regard, corresponding servo drivers, or similar controllers can be implemented for controlling the respective actuators within the timepiece.

Furthermore, in certain embodiments such as those depicted in FIGS. 6(a-f), the actuator can be disposed in a horizontal configuration (as opposed to a vertical actuator). In this regard, the horizontally disposed actuators provide a relatively thin body thereby improving portability, ergonomics, and aesthetics of the timepiece.

One having skill in the art will recognize that other actuators exist in the art and can be similarly incorporated to produce predictable results.

In another aspect of the invention, a method for displaying time or date information according to a Braille format is disclosed, the method includes:

(i) providing a timepiece comprising a dial surface, one or more translational pins adapted to translate between a first recessed position and a second raised position about the dial surface, and a CPU;

(ii) programming the CPU for representing the translational pins with corresponding numbers according to a Braille format;

(iii) sending instructions from the CPU to one or more actuators for actuating pins to a predetermined position for displaying one or more of time and date according to the Braille format using the translational pins.

The method may alternatively comprise the steps of:

(iv) providing an update button; and

(v) updating the Braille display to reflect instantaneous time upon user request by depressing the update button.

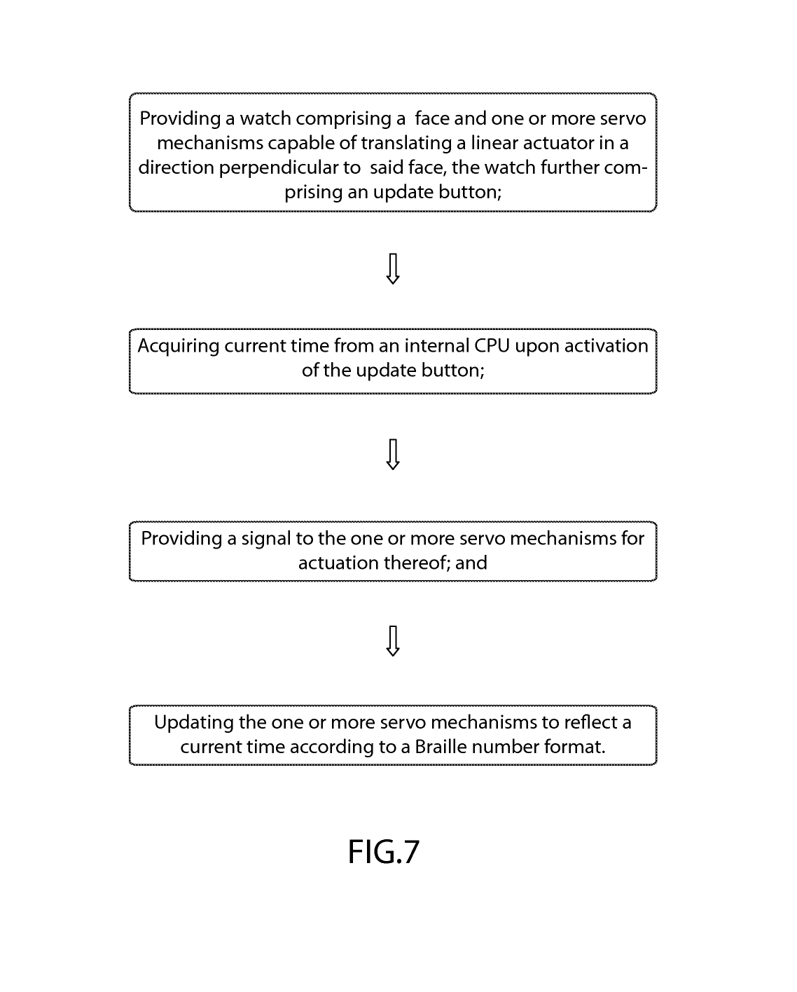

Another method is illustrated in FIG. 7.

The above examples are set forth for illustrative purposes and are not intended to limit the spirit and scope of the invention. One having skill in the art will recognize that deviations from the aforementioned examples can be created which substantially perform the same functions and obtain similar results.

I claim:

1. An active Braille timepiece, comprising:
a substantially planar dial surface;
three or more Braille character cells, each of said cells comprising four dots being disposed equidistant from a center point in a square orientation;
at least twelve translational pins, each of said translational pins having a distal end forming one of said dots;
each of said translational pins being independently adapted to actuate from a first recessed position to a second raised position about said dial surface;
a CPU adapted to store data relating to time; and
an update button;
wherein said update button is adapted to communicate with said CPU for actuating said translational pins and actively displaying an instantaneous time in Braille format about said dial surface.

2. The timepiece of claim 1, comprising four Braille character cells for actively displaying time in twenty-four hour format.

3. The timepiece of claim 1, comprising three Braille character cells and a supplemental dot, said supplemental dot formed at a distal end of a supplemental translational pin, said supplemental translational pin being adapted to actuate between a first recessed position and a second raised position about said dial surface.

4. The timepiece of claim 3, wherein said supplemental dot is adapted to indicate one or more of: two-digit hours and months.

5. The timepiece of claim 3, wherein said supplemental dot is adapted to indicate one or more of: anti-meridiem and post-meridiem hours.

6. The timepiece of claim 1, further comprising a vibrating motor consisting essentially of an electric motor having an offset load connected to a spinning rod thereof.

7. The timepiece of claim 1, further comprising an LCD display.

8. The timepiece of claim 1, further comprising a spring lever for actuating one or more of said translational pins.

9. The timepiece of claim 1, further comprising one or more dome cap actuators for actuating one or more of said translational pins.

10. The timepiece of claim 1, further comprising one or more cam shaft actuators for actuating one or more of said translational pins.

11. The timepiece of claim 1, further comprising one or more direct drive actuators for actuating one or more of said translational pins.

12. A wristwatch adapted for active time display in Braille, comprising:
a watch band;
a dial having a substantially planar surface thereof;
one or more buttons;
characterized in that said wristwatch further comprises a Braille actuation mechanism for actively displaying time in a Braille format, said Braille actuation mechanism comprising:
at least three Braille cells, each of said Braille cells comprising four actuators, wherein each of said four actuators further comprises a translational pin having a distal end adapted to translate between a first recessed position and a second raised position about said dial surface.

13. A method for providing active Braille display of numerical information on a timepiece, comprising:
(i) providing a timepiece comprising a dial surface, one or more translational pins adapted to translate between a first recessed position and a second raised position about the dial surface, and a CPU;
(ii) programming the CPU for representing the translational pins with corresponding numbers according to a Braille format; and
(iii) sending instructions from the CPU to one or more actuators for actuating pins to a predetermined position for displaying one or more of time and date according to the Braille format using the translational pins.

14. The method of claim 13, further comprising the steps:
(iv) providing an update button; and
(v) updating the Braille display to reflect instantaneous time upon user request by depressing the update button.
